(19) United States
(12) Patent Application Publication
(10) Pub. No.: US 2006/0079623 A1
(43) Pub. Date: Apr. 13, 2006

(54) Method of forming nanocomposite materials

(76) Inventor: Chenggang Chen, Beavercreek, OH (US)

Correspondence Address: DINSMORE & SHOHL LLP;One Dayton Centre, Suite 1300, One South Main Street, Dayton, OH, 45402-2023, US

(21) Appl. No.: 11/135,091

(22) Filed: May 23, 2005

Related U.S. Application Data
(63) Continuation-in-part of application No. 10/789,295, filed on Feb. 27, 2004.
Application No. 10/789,295 is a continuation-in-part of application No. 10/698,218, filed on Oct. 31, 2003.
Application No. 10/698,218 is a division of application No. 09/932,169, filed on Aug. 17, 2001, now Pat. No. 6,680,016.

(51) Int. Cl. C08K 9/04

(52) U.S. Cl. 524/445

(57) ABSTRACT

A method of making a polymeric nanocomposite material. The method includes combining nanosize materials, such as layered silicates, or tube-silicates, with a thermosetting polymer and a solvent to form a substantially homogeneous mixture, removing the solvent, adding a curing agent, and ultrasonicating the mixture.

### CROSS REFERENCE TO RELATED APPLICATIONS

This application is a continuation-in-part of U.S. patent application Ser. No. ______ filed on even date herewith, entitled “Method of Forming Nanocomposite Materials,” (Attorney Docket Number UVD 0307 I2), which is a continuation-in-part of U.S. patent application Ser. No. 10/789,295, filed Feb. 27, 2004, which is a continuation-in-part of U.S. patent application Ser. No. 10/698,218, filed Oct. 31, 2003, which application is a division of U.S. patent application Ser. No. 09/932,169, filed Aug. 17, 2001, now U.S. Pat. No. 6,680,016.

### BACKGROUND OF THE INVENTION

The present invention is directed to a nanocomposite material incorporating uniformly dispersed nanosize materials, and to a method of forming such a nanocomposite material.

Layered silicate polymer nanocomposites are a relatively new class of materials that are composed of soft polymeric phases and hard inorganic layered silicate phases of nanometer-scale thickness. There has been a great interest in layered silicate polymer nanocomposites since the development of layered silicate nylon nanocomposites.

The layered silicate most widely used in polymer nanocomposites is based on clay due to its low cost, availability, and well-developed intercalation chemistry.

In contrast to the aggregation of tactoids in traditional polymer-clay composite materials, layered silicate polymer nanocomposites are primarily catalogued as intercalated or exfoliated. In an intercalated nanocomposite, the polymer penetrates inside the gallery of the layered silicate, and expands the gallery to a larger interplanar spacing. The ordered structure of nanosilicate tactoids is preserved. In an exfoliated nanocomposite, the individual silicate nanolayer from the original aggregate of the nanosilicate tactoids should be separated from each other, and the individual silicate nanolayers homogenously and uniformly dispersed throughout the polymer matrix.

There are two morphology subtypes for exfoliation. One is ordered exfoliation, in which the ordered structure of the nanosilicate is preserved. In this case, a large amount of polymer penetrates inside the gallery, resulting in a completely homogeneous multilayer morphology consisting of alternating polymer and silicate nanolayers in the whole system. The interplanar spacing between the silicate nanolayers in this ordered exfoliated nanocomposite could be calculated based on the volume fraction of loading of the layered silicate. The interplanar spacing can be determined from small-angle-x-ray scattering. Transmission electron microscopy (TEM) provides the direct evidence and a clear image of this morphology. This differs from intercalated morphologies in that there are many pure polymer domains interspersed with silicate-rich domains in an intercalated nanocomposite, while an ordered exfoliated nanocomposite has a homogeneous dispersion throughout.

The other subtype of exfoliated morphology is disordered exfoliation, in which the ordered structure of the silicate nanolayers is completely destroyed, and each individual nanolayer is homogeneously and randomly dispersed in the whole polymer matrix. This type of morphology cannot be detected by x-ray scattering. But because there is a clear peak for the layered-silicate or intercalated layered-silicate polymer nanocomposite, the observation of no peak in the low angle region in the x-ray scattering verifies the exfoliated nanostructure. Simultaneously, this morphology can be clearly imaged and confirmed through TEM.

It is understood that morphology influences several material properties. Within conventional composites, the distinction between ordered and disordered exfoliation has become accepted, and it is expected that this difference in relative orientation of the individual layers will similarly play a role in certain properties. An ordered exfoliated nanostructure can provide for anisotropic behavior that can be exploited for certain properties such as barrier, toughness, or modulus. For example, the ordered platelets, if aligned perpendicular to the expected path of a permeant, would provide more effective barrier properties, while if they were aligned in the direction of strain, they could provide for higher stiffness. Although the anisotropic nature of nanocomposite morphologies has been recognized, to date experimental validation of the impact of these two morphologies has been lacking because of the challenges associated with processing such controlled morphologies.

The full dispersion of silicate nanolayers in the polymer matrix will optimize the benefit that the nanosilicates provide to the properties of polymeric materials. As is well understood from rigid particle composites, microparticles, such as nanoclays, in their aggregation state can increase the modulus but sacrifice toughness and strength. However, the ultralarge interfacial area per volume between the silicate nanolayers and polymer achieved when these silicate nanolayers are fully exfoliated provides for a new property trade space. Coupling between the silicate nanolayers and the polymer matrix now relies upon ultralarge interfacial areas and could assist in stress transfer to the silicate nanolayers to enable the simultaneous improvement of modulus, toughness, and strength. Similarly, the improvement of barrier properties, chemical and solvent resistance, thermal stability, and flame retardancy relies on the hindered tortuous diffusion paths created by these dispersed silicate nanolayers. Therefore, it has been increasingly accepted that fully exfoliated morphologies are most preferred for the enhancement of such properties through the nanocomposite approach.

Epoxies are a very common thermosetting material widely used in adhesives, coatings, electronic encapsulates, and advanced composites. Extensive research on layered silicate epoxy nanocomposites has been carried out, including the processing, preparation, and exfoliation mechanisms, and the incorporation of the epoxy nanocomposite as a matrix into the traditional carbon fiber-reinforced composites. An exfoliated nanostructure has often been assumed when x-ray diffraction cannot detect the (001) peak of the epoxy nanocomposite, mostly beyond about 80 Å. Based on the TEM images of epoxy nanocomposites in the literature, the distance between the silicate nanolayers generally ranged from 80 to 200 Å. This separation is significant; it is about 4 to 10 times larger than the interplanar spacing between the silicate nanolayers in the original organoclays (15 to 30 Å). The great expansion of the gallery of the layered silicate is due to the penetration of a large amount of epoxy resin inside the gallery. The dispersion of the silicate nanolayers in the matrix is relatively good, especially compared with some of the typical intercalated polymer nanocomposites (generally with the increase of the interplanar spacing of teens or tens of Å). However, the calculations based on a given volume fraction of layered silicate and the assumption of ordered exfoliated morphology in which the nanosheets remain parallel to each other indicates that the interplanar spacings should be about 1700 Å for 1 wt % clay loading, 550 Å for 3 wt % clay loading, 330 Å for 5 wt % clay loading, and 155 Å for 10 wt % clay loading. Therefore, although the dispersions achieved to date in the literature are good, with large separations of silicate nanolayers of 80 to 200 Å, the potential separation of the silicate nanolayers should be about 300 to 500 Å with an organoclay loading of 3 to 5 wt %. Therefore, some pure polymer domains devoid of silicate nanolayers should exist in these nanocomposites. This cannot be confirmed through high magnification TEM images alone and requires study of TEM images of both low and high magnification. This is even more important for full morphology descriptions of nanocomposites that have a combination of both exfoliated and intercalated morphologies. Therefore, an epoxy nanocomposite with 80 to 200 Å separation between the nanosilicate layers is not fully exfoliated, but rather is likely intercalated, or is a combination of exfoliated and intercalated morphologies. It is well established that the large expansion of the gallery between the nanolayers generally occurs during curing. However, crosslinking takes place during curing, and a three-dimensional network is gradually formed. The rigid structure will slow and/or prevent further expansion of the gallery. Thus, an intercalated morphology or a combination of exfoliated and intercalated morphology is generally obtained for the epoxy nanocomposite.

Accordingly, there is a need in the art for a method of making a fully exfoliated thermoset nanocomposite.

### SUMMARY OF THE INVENTION

The present invention meets this need by providing a method of forming a fully exfoliated thermoset nanocomposite. The method includes providing a nanosize material selected from layered silicates, tube-silicates, or combinations thereof; providing a polymer comprising a thermosetting resin; combining the nanosize material and the polymer with a solvent using high-shear mixing to form a substantially homogeneous mixture; removing the solvent from the mixture; adding a curing agent to the mixture; and ultrasonicating the mixture to form the fully exfoliated thermoset nanocomposite. As is well understood, by polymers, we mean that they also include monomers and other polymer precursors which will form polymers later.

### BRIEF DESCRIPTION OF THE DRAWINGS

FIG. 1 are TEM images of a nanocomposite containing 1.5 wt % organoclay (SC 18), epoxy resin (Epon 862), and curing agent (curing agent W) made using stir-bar mixing.

FIG. 2 is the small-angle x-ray scattering of the nanocomposite of FIG. 1.

FIG. 3 are TEM images of a nanocomposite containing 2.5 wt % organoclay (SC8), epoxy resin (Epon 862), and curing agent (curing agent W) made using stir-bar mixing.

FIG. 4 is the small-angle x-ray scattering of the nanocomposite of FIG. 3.

FIG. 5 are TEM images of a nanocomposite containing 5 wt % organoclay (SC18), epoxy resin (Epon 828), and curing agent (curing agent W) made using high-shear mixing.

FIG. 6 is the small-angle x-ray scattering of the nanocomposite of FIG. 5.

FIG. 7 is a TEM image of a nanocomposite containing 2.5 wt % organoclay 1.30E), epoxy resin (Epon 862), and curing agent (curing agent W) made using high-shear mixing.

FIG. 8 is the small-angle x-ray scattering of the nanocomposite of FIG. 7.

FIG. 9 are TEM images of a nanocomposite containing 2.5 wt % organoclay (SC18), epoxy resin (Epon 828), and curing agent (Jeffamine D230) made using high-shear mixing.

FIG. 10 are TEM images of a nanocomposite containing 2.3 wt % organoclay (SC18), epoxy resin (Epon 828), and curing agent (Jeffamine D400) made using high-shear mixing.

FIG. 11 is a TEM image of a hybrid nanocomposite containing 2 wt % organoclay (SC12), 1 Wt % SiO₂, epoxy resin (Epon 862), and curing agent (curing agent W) made using high-shear mixing.

FIG. 12 are TEM images of a nanocomposite containing 3 wt % organoclay (SC18), epoxy resin (Epon 862), and curing agent (curing agent W) made using high-shear mixing and ultrasonication.

FIG. 13 are graphs showing the wide-angle x-ray diffraction (FIG. 13A) and small-angle x-ray scattering (FIG. 13B) of a nanocomposite containing 3 wt % organoclay (SC 18), epoxy resin (Epon 862), and curing agent (curing agent W) made using high-shear mixing and ultrasonication.

### DETAILED DESCRIPTION OF THE INVENTION

Fully exfoliated layered-silicate epoxy nanocomposites can be achieved through the use of the combination of high-shear mixing of the nanosize material and thermoset polymer in the solvent and ultrasonication of the mixture after the curing agent has been added. The first step breaks up and disperses the organoclay in the solvent into the particle size of a micrometer. Although this expands the gallery of the layered-silicate to some extent, this step alone cannot achieve a fully exfoliated layered-silicate epoxy composite. The curing after the addition of the curing agent increases the interplanar spacing, allowing more separation of the individual silicate layers from one another during curing. The ultrasonication also provides more energy and causes further separation and better dispersion. This helps to achieve the fully exfoliated nanostructure.

The method of the present invention achieves uniform dispersion of nanosize materials in polymer matrices by dissolving the polymer in a solvent with the nanosize materials. While the nanosize materials of the present invention alone do not disperse well in polymers, we have found that they disperse very well in the presence of an organic solvent. We have found that this method is more effective in uniformly dispersing nanosize materials into polymer matrices than prior art methods such as melt blending. By “uniformly dispersed,” it is meant that the nanosize materials are uniformly dispersed throughout the polymer matrix with minimal degradation of their large aspect ratio. Accordingly, the nanosize materials are combined with the polymer and solvent to form a substantially homogeneous mixture, followed by removal of the solvent. By “substantially homogeneous mixture,” it is meant that the nanosize materials are uniformly dispersed in the solution mixture. The curing agent is then added, and the mixture is ultrasonicated.

The resulting polymer nanocomposite material can be further processed into various shapes and forms by conventional polymer extrusion and molding techniques.

The method of the present invention provides an advantage over prior melt-blending processes in that it utilizes a low-temperature solution process, (i.e., no heat is required to melt the polymer) to disperse the nanosize materials.

The use of nanosize materials comprising layered silicates results in polymeric nanocomposite materials having one or more improved properties. It should be understood that there need not be improvement in all properties for a useful composite. The electrical properties of the nanocomposite, including dielectric constant and dielectric nanocapacitance, are unique and can be tailored to specific applications. The nanocomposites have increased mechanical properties, improved durability, increased dimensional stability, and improved abrasion resistance. They also have a reduced coefficient of thermal expansion, increased thermal capabilities, and improved fire retardancy. The nanocomposites have reduced microcracking and outgassing, reduced permeability, and increased damping capabilities. They also mitigate material property dissimilarities across joints. In addition, they have increased property retention in extreme environments such as atomic oxygen in low earth orbital in outer space, and oxygen plasma. Thus, the nanocomposites of the present invention are multifunctional.

Suitable polymers for use in the present invention include various thermosetting polymers. Any thermosetting polymer may be used in the present invention as long as it is soluble in a solvent. Suitable polymers include, but are not limited to, epoxies, cyanaster esters, polyimides, polybenzoxanes, phenolics, or combinations thereof. Suitable epoxy resins include Epon 862 or Epon 828, commercially available from Shell Chemical Co. The polymer is generally present in a concentration of at least about 80 wt %, typically about 90 wt % to about 99 wt %. It should be appreciated that the concentration of the polymer may vary depending on the desired properties and applications, such as coatings, of the resulting composite material.

Suitable layered silicates for use in the present invention are commercially available from Southern Clay Products, and Nanocor, or can be synthesized through well-established ion-exchange chemistry. Suitable tube silicates are commercially available from Ward's Natural Silicate. The layered or tube silicates can be present in an amount up to about 20 wt % or more in the final product, typically about 1 to about 10 wt %. A concentrate containing a higher weight percentage of silicates could be prepared, and the concentrate could then be diluted with polymer to form the final desired product.

The solvent can be removed from the mixture, and a curing agent added to cure the resin. Suitable curing agents for use in the present invention include, but are not limited to, amines, anhydrides, and catalysts. Suitable amines include, but are not limited to, multi-functional amines. Suitable curing agents include, but are not limited to, diethyltoluenediamine (available from Shell); Jeffamine® curing agents (such as D230, D400, D2000, and T403) available from Huntsman Chemical; diethyltriamine; triethyltetramine; 4,4′-diaminodiphenylmethane; 1,3-phenyldiamine; polyaminoamide; and nadic methyl anhydride. 4-aminophenyl sulfone and 3-aminophenyl sulfone are desirable amine curing agents because epoxies made using them have a very high Tg after cure.

An optional coupling agent may also be added. Suitable coupling agents include, but are not limited to, 3-glycidoxypropyltrimethoxy silane and 3-aminopropyltrimethoxy silane.

Suitable solvents include, but are not limited to, acetone, methylethyl ketone, tetrahydrofuran, methylene dichloride, chloroform, toluene, xylene, 1-methyl pyrrolidinone, N,N-dimethyl acetamide, N,N-dimethyl foramide, dimethyl sulfoxide, polyphosphoric acid, butyl acetate, water, and mixtures thereof.

The method of the present invention is carried out by combining the nanosize material and the desired polymer in a solvent, preferably in a closed container. This can be accomplished in a variety of ways. The nanosize material can be dispersed in the solvent using high shear mixing, the polymer can be mixed with the solvent, and the nanosize material/solvent mixture and polymer/solvent mixture can be mixed together with high shear mixing. By high shear mixing, we mean mixing with a shear rate of about 8,000 to about 30,000 rpm

Alternatively, the nanosize material, polymer and solvent may be combined at the same time using high shear mixing. Another method involves dispersing the nanosize material in the solvent with high shear mixing, and adding the polymer (without solvent) with high shear mixing. Still another method involves mixing the nanosize material with the polymer using stir bar mixing for about 2 hours at a temperature of about 60° C., then mixing in the solvent using high shear mixing. The preferred method of combining the components will vary depending on the solubility of the polymer being used.

The use of high shear mixing does not appear to destroy the structure of layered silicate. As a result, there does not seem to be an upper limit on the time for high shear mixing. The minimum time is the amount of time needed to achieve a good dispersion, which is generally at least about 30 minutes, although in some cases it could be less.

The high shear mixing can be performed in a sonication bath, if desired. The use of the sonication bath helps disperse the particles. It also helps to maintain a relatively stable temperature during processing.

Generally, the solvent is removed before the curing agent is added. Removing the solvent before the curing agent is added is advantageous because no particular limits apply to its removal at that time. However, it can be removed after the curing agent has been added, if desired. This is less desirable because curing rate affects the solvent removal. The solvent would have to be removed before the viscosity becomes too high, which would vary depending on the polymer, the curing agent, and the amounts of the various components, making control of the process more difficult. In addition, more material must be ultrasonicated if the solvent is not removed before the curing agent is added.

After the solvent is removed, the mixture may be ultrasonicated, if desired. In general, this ultrasonication step will last between about 0.2 and about 6 hours.

The curing agent is then added, and the mixture is ultrasonicated. Ultrasonication may be achieved using a sonic dismemebrator. In an ultrasonicator, the circuitry provides more intense power to the probe tip, which makes it possible to mix, disperse, emulsify, and homogenize the samples. Ultrasonication is more intense and more powerful than the general bath sonication. This ultrasonication step will generally be in the range of about 10 min. to about 60 min. One criteria for the timing is that the ultrasonication should not increase the viscosity too much.

It may be desirable to include a dispersing agent when combining the nanosize material with the polymer and solvent to ensure a uniform dispersion of the materials. Suitable dispersing agents for use in the present invention include oils, plasticizers, and various surfactants. Suitable oils include vegetable and mineral oils including, but not limited to, castor oils, modified castor oils, soybean oils, modified soy bean oils, rape seed and canola oils, mineral oils, petroleum greases and lubricants. Suitable plasticizers include adipates, esters, oleates, phthalates, epoxides, and polymeric and monomeric plasticizers commonly used in industrial and specialty applications.

The resulting nanocomposite material may be further processed according to the desired application. For example, the nanocomposite material may be formed into a thin film which is cast from the solution mixture by evaporating the solvent at a temperature which is at or below the boiling point of the solvent. Alternatively, the solvent may be removed by coagulation in which the solution mixture is formed into a film or fiber and then immersed in a nonsolvent, such as water, to coagulate the film. The solution mixture may also be formed into thin films by spin coating and dip coating methods. The solution mixture may also be formed into large components such as thick sheets or panels by spraying or deposition, or by extruding or molding the dried composite material.

The nanocomposite material comprising layered silicates may be formed into structural adhesives, coatings, inks, films, extruded shapes, thick sheets, molded parts, and large structural components.

In order that the invention may be more readily understood, reference is made to the following examples which are intended to illustrate the invention, but not limit the scope thereof.

A series of experiments were run to compare the effect of different methods of mixing.

One method was the stir-bar mixing method. In this method, an epoxy resin and the organoclay were mixed using a stirring bar at elevated temperature (about 60° C.) for about 2 to 4 hours. The mixture was degassed and the stoichiometric amount of curing agent was added. The mixture was degassed and cured in the mold.

### EXAMPLE 1

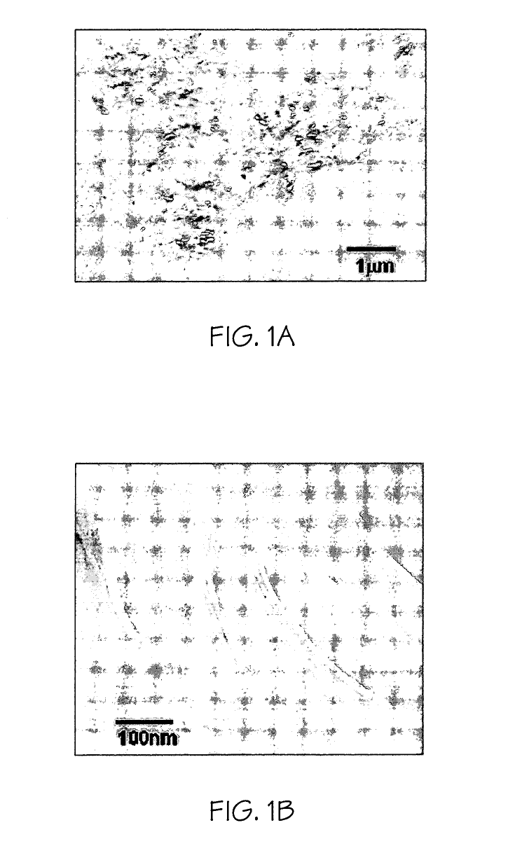

A nanocomposite was made with 1.5% organoclay (SC18), epoxy resin (Epon 862), and a curing agent (curing agent W (diethyltoluenediamine)) using the stir-bar method. The x-ray diffraction of the cured nanocomposite shows that the interplanar spacing is more than 100 Å. Although an exfoliated nanostructure is often assumed in most literature when x-ray diffraction cannot detect the (001) peak of the epoxy nanocomposite (mostly beyond about 80 Å), we have found that they are not strictly exfoliated at all. The TEM image of FIG. 1 shows that the silicate nanosheets are stacked together. The size for the aggregation is from 1 to teen μm. The interplanar spacing is from 10 to 20 nm.

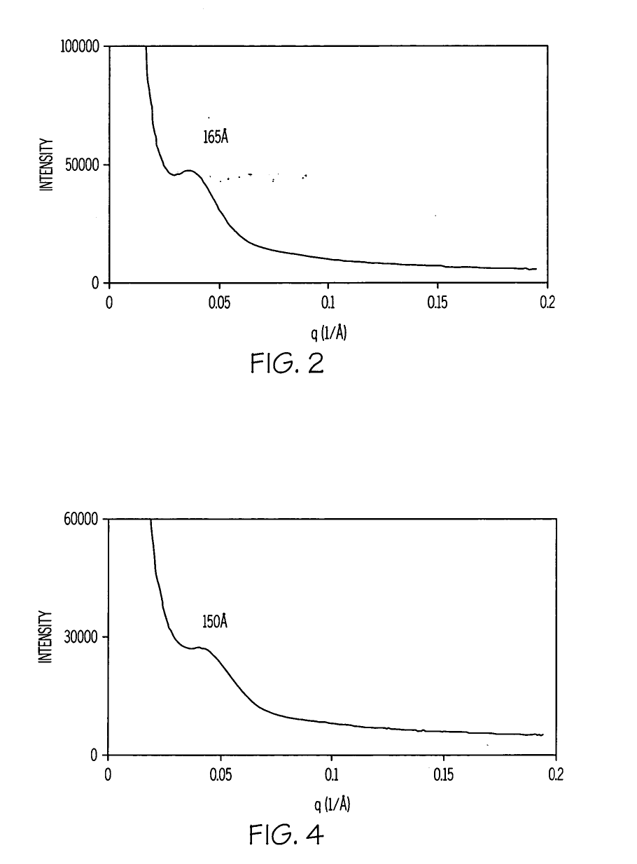

The small-angle x-ray scattering (SAXS) was used to characterize the morphologies of the composites further. The small-angle x-ray scattering of this nanocomposite is shown in FIG. 2. SAXS data indicated that the interplanar spacing was about 165 Å in the ordered structure of the nanocomposite. Compared with the original interplanar spacing of about 18 Å of organoclay SC18, the gallery of the organoclay was greatly expanded. The expansion of the gallery is due to the penetration of the large amount of epoxy resin inside the gallery. The expansion is so large that the dispersion of layered silicate in the polymer matrix is good. However, it is an intercalated nanocomposite with a very large interplanar spacing (165 Å).

### EXAMPLE 2

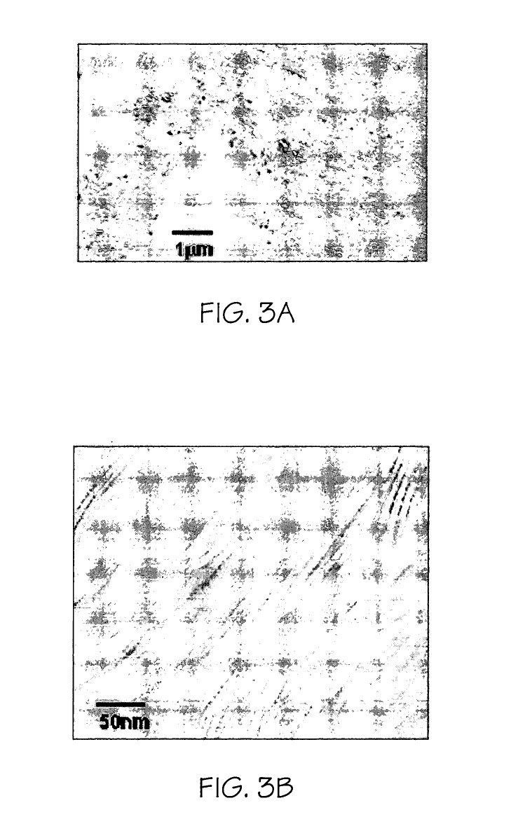

A nanocomposite was made with 2.5% organoclay (SC8), epoxy resin (Epon 862), and a curing agent (curing agent W). The TEM image is shown in FIG. 3. The particle size is very large. Some particles can be as large as teen μm. The TEM image at high magnification is typically from 15 to 20 nm.

The small-angle x-ray scattering of this nanocomposite is shown in FIG. 4. SAXS data indicated that the interplanar spacing is about 150 Å. Compared with the original interplanar spacing of 13.4 Å for organoclay SC8, the gallery of the organoclay was greatly expanded. However, it is an intercalated nanocomposite with very large interplanar spacing (150 Å).

A high-shear mixing method was also evaluated. In this method, the organoclay was dispersed in a solvent (acetone) using a high-shear mixer in a sonication bath for about 3 to 6 hours. The epoxy resin and solvent (acetone) mixture was then added to the suspension and mixed by high-shear mixing in the sonication bath. After the high-shear mixing, the solvent was evaporated. The curing agent was added to the mixture, which was degassed, and cured.

### EXAMPLE 3

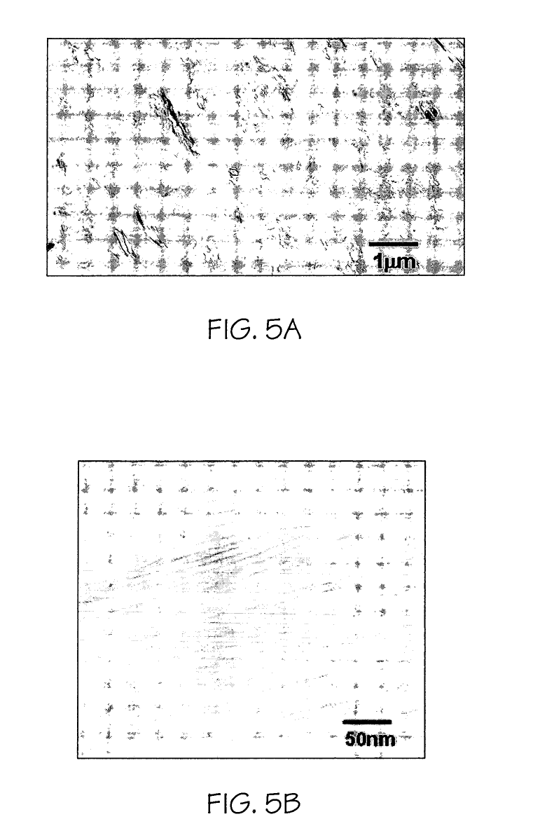

A nanocomposite was made with 5% organoclay (SC18), epoxy resin (Epon 828), and a curing agent (curing agent W). The TEM images are shown in FIG. 5. The images show that the organoclays are broken into smaller particles, but that the size is from 0.1 to 2 μm, and the individual clay nanosheets are stacked together. The particle containing the stacking clay nanosheets is much smaller than the particle using the stir-bar mixing method. The particle size is also determined by the shearing tool, which is generally for the micron-sized particle separation, not for the nanometer-sized particle separation. The interplanar spacing between the nanolayers is about 150 Å, which is consistent with the SAXS data discussed below. In addition, TEM image clearly shows that the organoclay was better dispersed in the whole polymer matrix than nanocomposites made with stir-bar mixing. However, each particle contains stacking of the individual nanosheets.

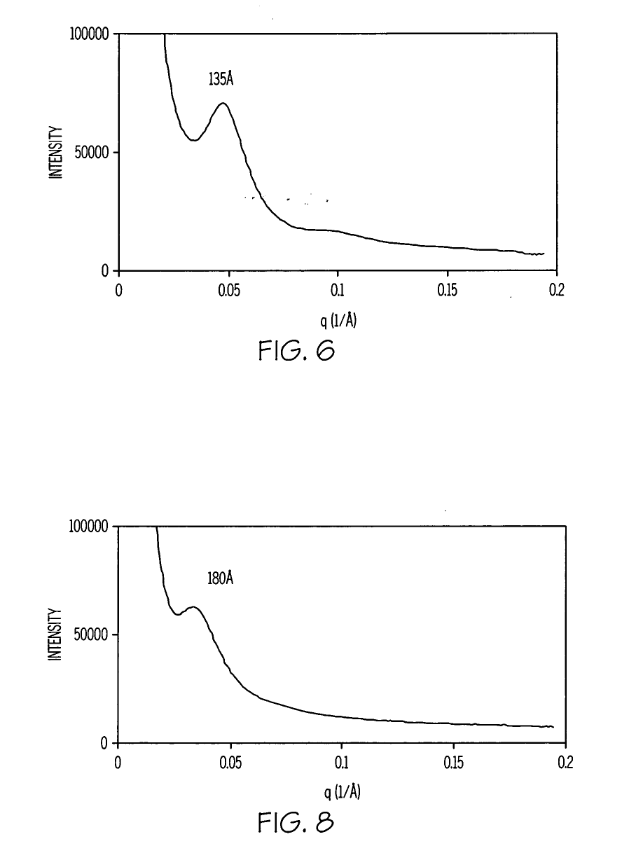

The small-angle x-ray scattering of this nanocomposite is shown in FIG. 6. SAXS data indicates that the interplanar spacing is about 135 Å in the ordered structure of the nanocomposite. Compared with the original interplanar spacing of 18 Å of organoclay SC 18, the gallery of the organoclay was greatly expanded. However, this is an intercalated nanocomposite with very large interplanar spacing.

### EXAMPLE 4

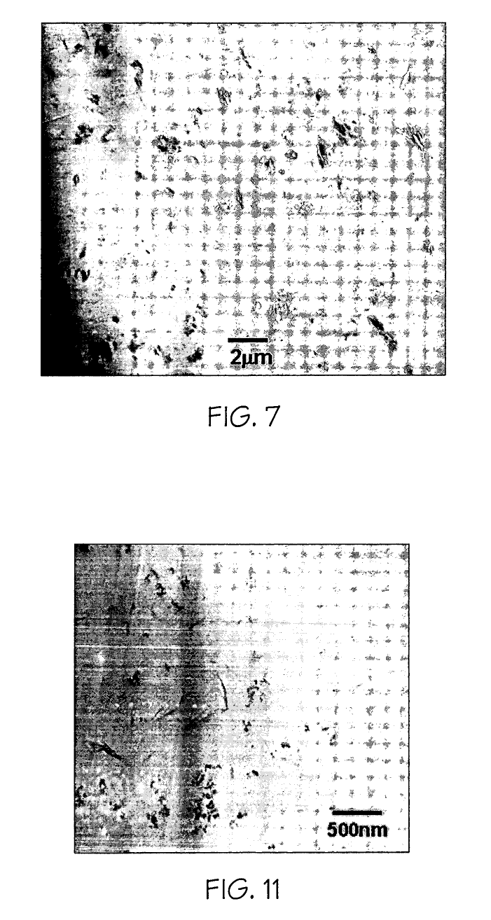

A nanocomposite was made with 2.5% organoclay 1.30E), epoxy resin (Epon 862), and a curing agent (curing agent W). The TEM images are shown in FIG. 7. The image is very similar to the TEM images in FIG. 5, indicating relatively good dispersion with particle size from 0.1 to 1-2 μm, which is composed of the stacking of individual clay nanosheets. The aggregation size of the layered silicate is smaller and the layered silicate is better dispersed in the whole polymer matrix than nanocomposites made by stir-bar mixing.

The small-angle x-ray scattering of this nanocomposite is shown in FIG. 8. SAXS data indicated that the interplanar spacing is about 180 Å in the ordered structure of the nanocomposite. Compared with the original interplanar spacing of about 22 Å of organoclay 1.30E, the gallery of the organoclay was greatly expanded. However, this is an intercalated nanocomposite with very large interplanar spacing (180 Å).

### EXAMPLE 5

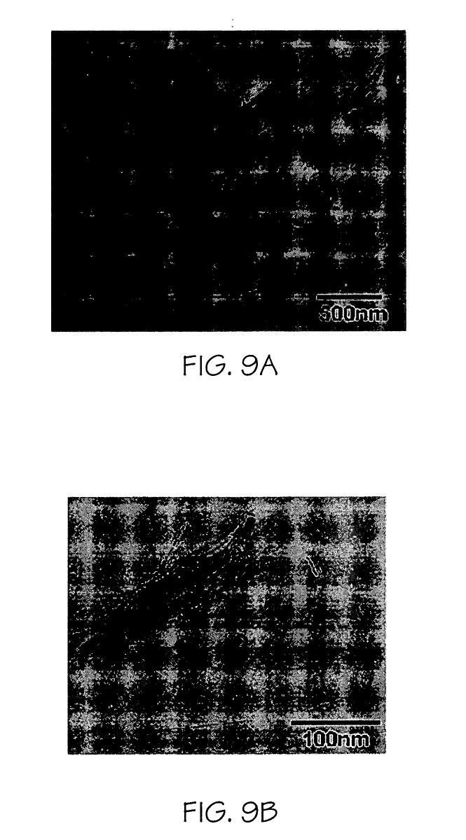

A nanocomposite was made with 2.5% organoclay (SC18), epoxy resin (Epon 828), and a curing agent (Jeffamine D230). The TEM images are shown in FIG. 9. The dispersion of the layered silicate is very good. However, each particle contains one to several individual silicate nanosheets. It has a mixed morphology of a combination of intercalated and partially exfoliated nanostructure.

### EXAMPLE 6

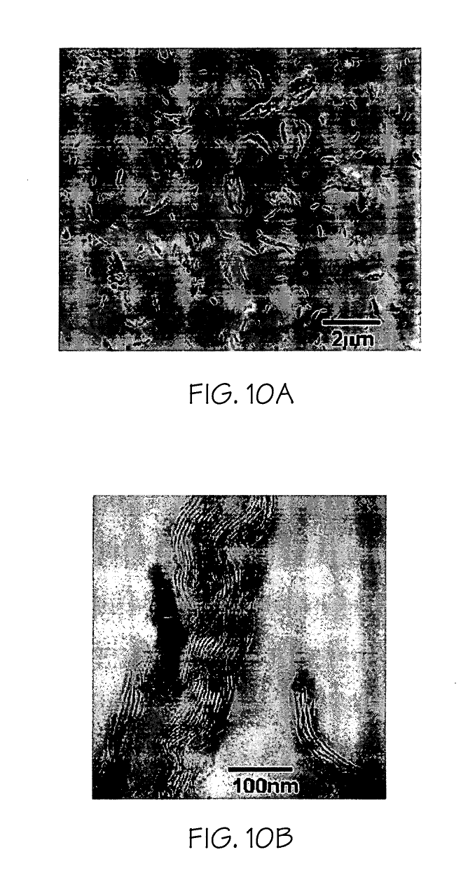

A nanocomposite was made with 2.3% organoclay (SC18), epoxy resin (Epon 828), and a curing agent (Jeffamine D400). The TEM images are shown in FIG. 10. The dispersion of the layered silicate in the whole matrix is very good. But each particle contains several individual silicate nanosheets. It has the mixed morphology of a combination of intercalated and partially exfoliated nanostructure.

### EXAMPLE 7

A nanocomposite was made with 2% organoclay (SC12), 1 wt % SiO₂, epoxy resin (Epon 862), and a curing agent (curing agent W). The desired amount of the spherical silica organoclay was mixed with acetone by high shear mixing in the ultrasonication bath for 2 hours. Then, the desired amount of Epon 862 with acetone was added, and high shear mixing of the resulting mixture in the ultrasonication bath was continued for 6 hours. The solvent was evaporated, and the mixture degassed. Then, the stoichiometric amount of curing agent W was added and mixed by stir bar. The mixture was degassed and cured. The TEM images of this nanocomposite are shown in FIG. 11. The TEM image shows that the spherical silica particles and layered-silicate are dispersed in the epoxy matrix. Although the dispersion is relatively good, both the spherical silica and layered-silica are in the state of small aggregation.

A high-shear mixing combined with ultrasonication was evaluated. In this method, the organoclay was dispersed in a solvent (acetone) using high-shear mixing in a sonication bath. The epoxy resin and solvent (acetone) were then added to the suspension and mixing continued with high-shear in the sonication bath for about 6 hours. The solvent was evaporated, and the resulting mixture was ultrasonicated for about 1 hour. The mixture was combined with a stoichiometric amount of curing agent, followed by ultrasonication for 1 hour. The resulting mixture was cast in a mold and cured.

### EXAMPLE 8

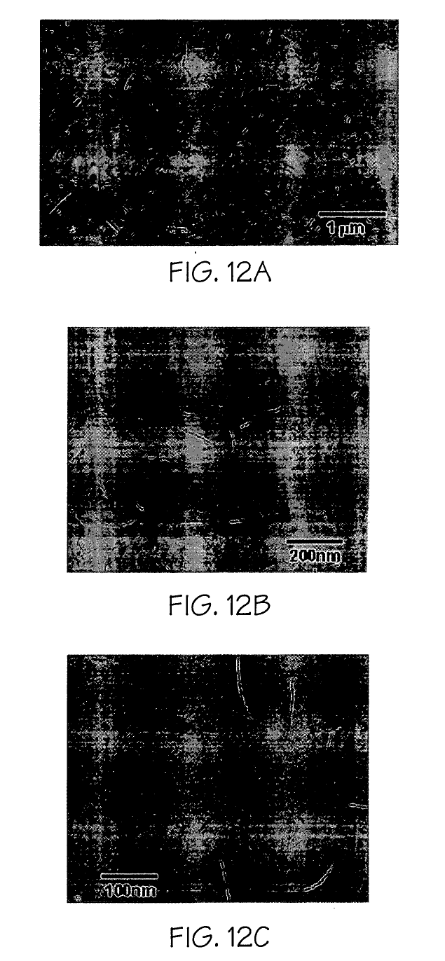

A nanocomposite was made with 3% organoclay (SC18), epoxy resin (Epon 862), and a curing agent (curing agent W). The cured sample appeared extremely clear. The TEM images are shown in FIG. 12. The dark lines are the silicate nanolayers. Each individual silicate nanolayer is distorted and homogeneously and randomly dispersed throughout the epoxy matrix. The distribution of the silicate nanolayers is very close to the theoretical potential of an ideal disordered exfoliation and represents almost perfect exfoliated nanostructural morphology. The homogeneous nature of the morphology can be clearly seen from the image at low magnification. The dimensional (length and width) size of the silicate nanolayers ranged from 100 nm to 400 nm, while the thickness appears larger than 1 nm. This is because the individual silicate nanolayer appears to have some curvature, and such curved nanolayers appear thicker because TEM is a two-dimensional projection of the three-dimensional materials. The curvature of the silicate nanolayers is due to their high aspect ratio.

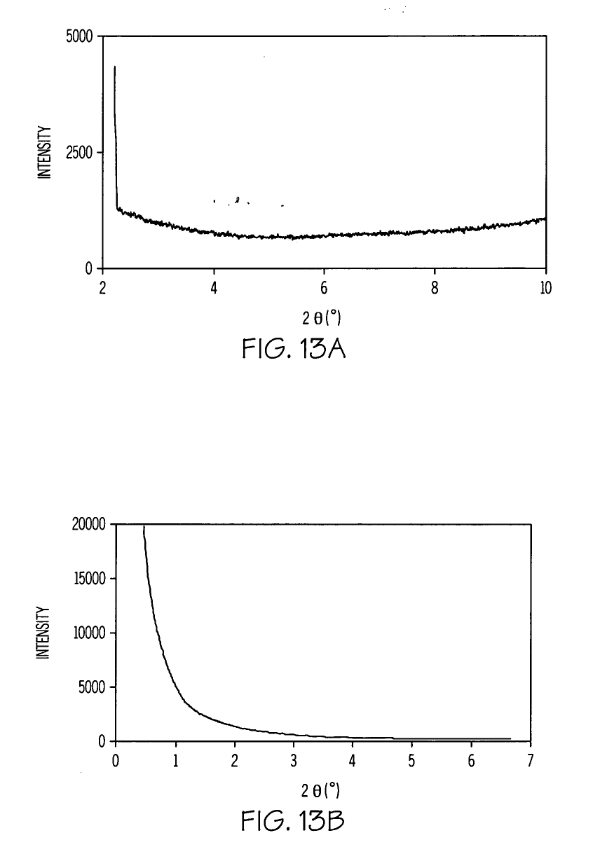

Simultaneously, x-ray diffraction provides for supplemental supporting evidence of the dispersion of the nanoclay. Wide-angle x-ray diffraction (WAXD) of this nanocomposite is shown in FIG. 13A. No peak is evident down to 2 Θ of 2.2° for this epoxy nanocomposite sample, indicating large interplanar spacing (more than 40 Å). In addition, small-angle x-ray scattering (SAXS) was used to further characterize the morphologies. The SAXS data for the nanocomposite is shown in FIG. 13B. There is no peak in the small-angle region, confirming the fully exfoliated nanostructure, consistent with the results from TEM.

It will be obvious to those skilled in the art that various changes may be made without departing from the scope of the invention which is not to be considered limited to what is described in the specification.

What is claimed is:

1. A method of forming a fully exfoliated thermoset nanocomposite comprising:
providing a nanosize material selected from layered silicates, tube-silicates, or combinations thereof;
providing a polymer comprising a thermosetting resin;
combining the nanosize material and the polymer with a solvent using high-shear mixing to form a substantially homogeneous mixture;
removing the solvent from the mixture;
adding a curing agent to the mixture; and
ultrasonicating the mixture to form the fully exfoliated thermoset nanocomposite.

2. The method of claim 1 wherein the thermosetting resin is selected from epoxies, cyanaster esters, polyimides, polybenzoxanes, phenolics, or combinations thereof.

3. The method of claim 1 wherein the curing agent is selected from amines, anhydrides, metallic catalysts, or combinations thereof.

4. The method of claim 1 wherein the solvent is removed by evaporation.

5. The method of claim 1 further comprising adding a dispersing agent when combining the nanosize material, polymer, and solvent.

6. The method of claim 5 wherein the dispersing agent is selected from oils, plasticizers, surfactants, or combinations thereof.

7. The method of claim 1 in which the solvent is selected from acetone, methylethyl ketone, tetrahydrofuran, methylene dichloride, chloroform, toluene, xylene, 1-methyl pyrrolidinone, N,N-dimethyl acetamide, N,N-dimethyl foramide, dimethyl sulfoxide, polyphosphoric acid, butyl acetate, water, or mixtures thereof.

8. The method of claim 1 further comprising adding a coupling agent.

9. The method of claim 8 wherein the coupling agent is selected from 3-glycidoxypropyltrimethoxy silane, 3-aminopropyltrimethyoxy silane.

10. The method of claim 1 wherein the nanosize material is combined with the solvent using high shear mixing before the polymer is added.

11. The method of claim 1 wherein the polymer is combined with the solvent before the nanosize material is added.

12. The method of claim 1 wherein combining the nanosize material and the polymer with the solvent using high-shear mixing to form the substantially homogeneous mixture comprises:
dispersing the nanosize material in the solvent using high shear mixing;
combining the polymer with the solvent; and
combining the nanosize material/solvent mixture with the polymer/solvent mixture using high shear mixing.

13. The method of claim 1 further comprising ultrasonicating the mixture after the solvent has been removed and before the curing agent is added.

14. A method of forming a fully exfoliated thermoset nanocomposite comprising:
providing a nanosize material selected from layered silicates, tube-silicates, or combinations thereof;
providing a polymer comprising a thermosetting resin selected from epoxies, cyanaster esters, polyimides, polybenzoxanes, phenolics, or combinations thereof;
dispersing the nanosize material in a solvent using high shear mixing;
combining the nanosize material/solvent dispersion and the polymer using high-shear mixing to form a substantially homogeneous mixture;
removing the solvent from the mixture;
adding a curing agent to the mixture; and
ultrasonicating the mixture to form the fully exfoliated thermoset nanocomposite.

15. The method of claim 14 wherein the polymer is combined with the solvent before combining with the nanosize material/solvent dispersion.

16. The method of claim 11 wherein the solvent is removed by evaporation.

17. The method of claim 11 further comprising adding a dispersing agent when combining the nanosize material, polymer, and solvent.

18. The method of claim 11 further comprising adding a coupling agent.

19. The fully exfoliated thermoset nanocomposite made by the method of claim 1.

20. The fully exfoliated the rmoset nanocomposite made by the method of claim 14.
